(19) United States
(12) Patent Application Publication
(10) Pub. No.: US 2026/0112948 A1
(43) Pub. Date: Apr. 23, 2026

(54) METHOD FOR MANUFACTURING IRON CORE PIECE

(71) Applicant: AISIN CORPORATION, Kariya (JP)

(72) Inventors: Hajime NISHIGUCHI, Kariya-shi (JP); Tatsuaki MIKI, Kariya-shi (JP)

(73) Assignee: AISIN CORPORATION, Kariya (JP)

(21) Appl. No.: 19/259,197

(22) Filed: Jul. 3, 2025

(30) Foreign Application Priority Data
Oct. 17, 2024 (JP) 2024-181567

(51) Int. Cl. H02K 15/021

(52) U.S. Cl. CPC H02K 15/021

(57) ABSTRACT

A method for manufacturing an iron core piece constituting a laminated iron core includes: forming magnet holes in a plate-shaped member while peripheries of the magnet holes are sandwiched by a stripper and a die, each of the magnet holes having long sides and short sides; defining a region surrounded by positions of the long sides and an outer peripheral edge of the iron core piece as a region of interest and forming the outer peripheral edge in at least a part of a portion excluding a circumferential end portion of an outer peripheral edge in the region of interest in a state where a radially inner side of the outer peripheral edge is sandwiched by a stripper and a die; and punching the iron core piece such that parts between outer peripheral edges of the core piece in plural regions of interest are connected in the circumferential direction.

### CROSS REFERENCE TO RELATED APPLICATIONS

This application is based on and claims priority under 35 U.S.C. §119 to Japanese Patent Application 2024-181567, filed on October 17, 2024, the entire content of which is incorporated herein by reference.

### TECHNICAL FIELD

This disclosure relates to a method for manufacturing an iron core piece.

### BACKGROUND DISCUSSION

In the related art, a technique for manufacturing a laminated iron core used for a motor or the like by laminating a plurality of iron core pieces is known. In each iron core piece, a plurality of magnet holes for disposing a permanent magnet are formed at positions close to an outer peripheral edge of the iron core piece. Since a bridge between the outer peripheral edge of the iron core piece and each magnet hole may be narrow in width and weak in strength, when the iron core piece is punched from a workpiece after the magnet hole is formed in the workpiece, a large stress is applied to the bridge, which may lead to deformation of the iron core piece. Therefore, a technique for preventing deformation of an iron core piece has been proposed in the related art. For example, Japanese Patent No. 6301822 (Reference 1) discloses a technique for a method for punching an iron core piece (11) having a bridge (13) between a radially outer end (12a) of a magnet insertion hole (10) and an outer region (12) of the iron core piece (11), and the method includes a step of forming a through hole (22) for forming a radially outer contour (13d) of the bridge (13) before a step of performing outer diameter punching on the iron core piece (11) (claim 1, and paragraph and FIG. 1A in specification of Reference 1). Accordingly, twisting of the bridge is less likely to occur, deformation or strength reduction of the iron core piece can be prevented, shape accuracy of a rotor iron core is maintained, and motor characteristics are not reduced (paragraph in the specification of Reference 1). One reason why twisting of the bridge (13) is less likely to occur is that a moment A applied to the bridge (13) when the magnet insertion hole (10) is formed and a moment B applied to the bridge (13) when the through hole (22) is punched are in opposite directions and offset (paragraphs and and FIGS. 1B and 2B in the specification of Reference 1).

Here, a region surrounded by the magnet hole and the outer peripheral edge of the iron core piece is more likely to deform when final punching of the iron core piece is performed as compared with a region in which no magnet hole is formed.

However, in the technique of Reference 1, since only the radially outer contour of the bridge is formed in the step of forming the through hole, the deformation due to the twisting of the bridge can be prevented, but it is not possible to prevent the deformation of the region surrounded by the magnet hole and the outer peripheral edge of the iron core piece.

A need thus exists for a a method for manufacturing an iron core piece which is not susceptible to the drawback mentioned above.

### SUMMARY

According to an aspect of this disclosure, a method for manufacturing an iron core piece constituting a laminated iron core based on a plate-shaped member and having a plurality of magnet holes arranged side by side in a circumferential direction, includes: a magnet hole forming step of forming the plurality of magnet holes in the plate-shaped member in a state where peripheries of the plurality of magnet holes are sandwiched by a stripper and a die, each of the plurality of magnet holes having long sides that face each other and short sides that are shorter than the long sides and connect both ends of the respective long sides, a length of the long sides in the circumferential direction being larger than a length thereof in a radial direction; an outer peripheral edge forming step of defining a region surrounded by positions of the long sides and an outer peripheral edge of the iron core piece as a region of interest and forming the outer peripheral edge of the iron core piece in at least a part of a portion excluding a circumferential end portion of an outer peripheral edge in the region of interest in a state where a radially inner side of the outer peripheral edge of the iron core piece is sandwiched by a stripper and a die; and a punching step of punching the iron core piece such that parts between outer peripheral edges of the iron core piece that are formed in the outer peripheral edge forming step in a plurality of regions of interest are connected in the circumferential direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an overall plan view of an iron core piece;

FIG. 2 is an enlarged plan view illustrating a portion A in FIG. 1;

FIG. 3 is a diagram illustrating a flow of a method for manufacturing the iron core piece;

FIG. 4A is an enlarged plan view illustrating a portion B in FIG. 2 and illustrates a state around a region of interest after step S120 in FIG. 3; FIG. 4B is an enlarged plan view illustrating the portion B in FIG. 2 and illustrates an outer peripheral edge of a punch in step S130 in FIG. 3; FIG. 4C is an enlarged plan view illustrating the portion B in FIG. 2 and illustrates a state around the region of interest after step S130 in FIG. 3;

FIG. 5A is a schematic cross-sectional view of a mold before molding in step S120 in FIG. 3; FIG. 5B is a schematic cross-sectional view of the mold after molding in step S120 in FIG. 3;

FIG. 6A is a schematic cross-sectional view of a mold before molding in step S130 in FIG. 3; FIG. 6B is a schematic cross-sectional view of the mold after molding in step S130 in FIG. 3; and

FIG. 7 is a schematic view illustrating a deformed state of an iron core piece during outer diameter punching and molding in the related art.

### DETAILED DESCRIPTION

Here, an embodiment of a method for manufacturing an iron core piece will be described in the following order.

1 Configuration of Iron Core Piece:

(2) Manufacturing Procedures of Iron Core Piece:

### 3 Other Embodiments:

### 1. Configuration of Iron Core Piece:

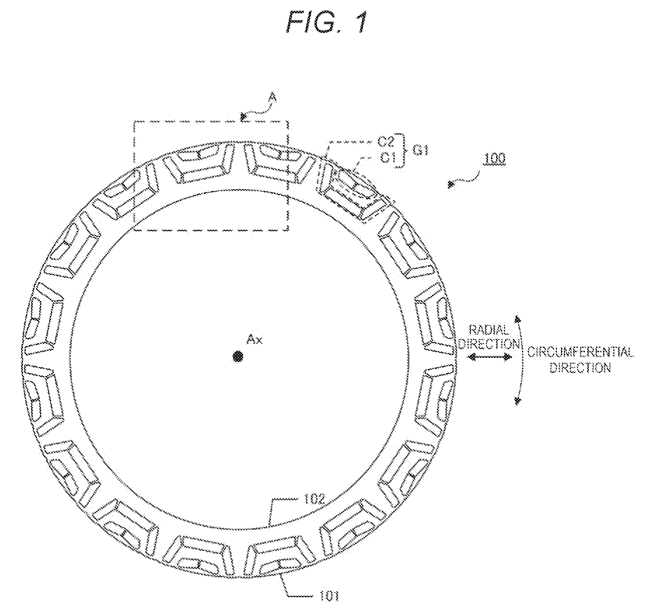

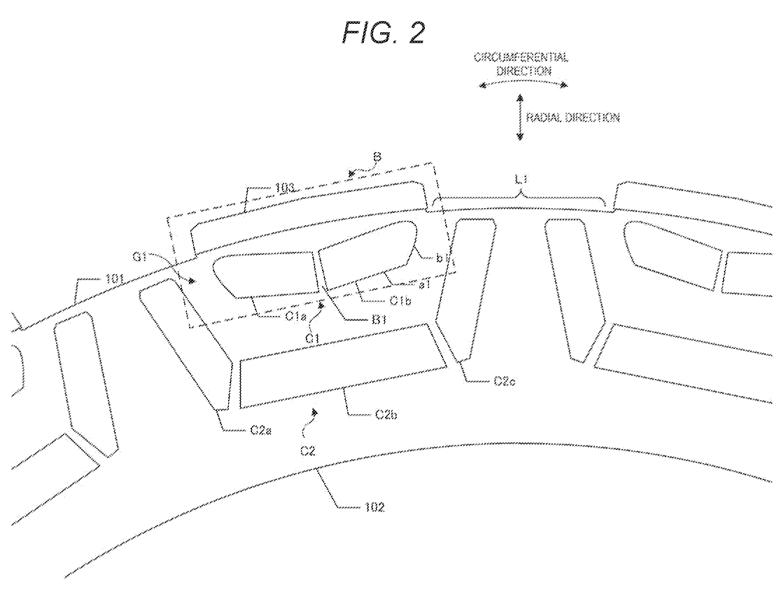

FIG. 1 is an overall plan view of an iron core piece according to an embodiment. FIG. 2 is an enlarged plan view illustrating a portion A in FIG. 1.

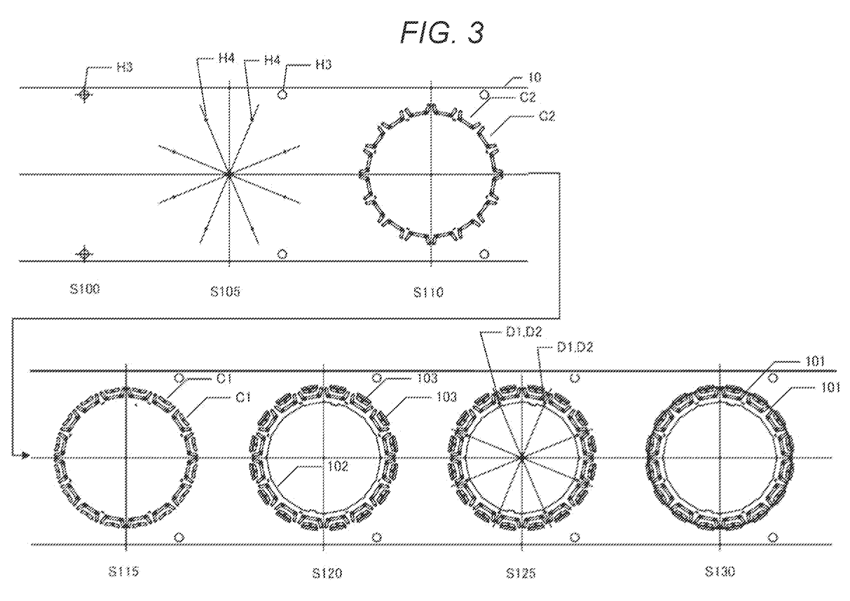

A laminated iron core used for a rotor of a motor or the like is manufactured by laminating a plurality of iron core pieces 100. Each of the iron core pieces 100 is manufactured based on a plate-shaped member 10 (see FIG. 3). That is, the iron core piece 100 is manufactured by processing the plate-shaped member 10. Here, a configuration of the manufactured iron core piece 100 will be described.

The iron core piece 100 is formed in a substantially annular shape having an outer peripheral edge 101 in a substantially circular shape and an inner peripheral edge 102 in a substantially circular shape with a diameter smaller than that of the outer peripheral edge 101. In the present specification, a center of a circle of the outer peripheral edge 101 or the inner peripheral edge 102, which is formed or to be formed on the plate-shaped member 10, is referred to as a rotation axis Ax, and a direction parallel to the rotation axis Ax is referred to as an axial direction. A direction along a circumference of a circle about the rotation axis Ax is referred to as a circumferential direction, and a direction parallel to a radius of the circle is referred to as a radial direction.

The iron core piece 100 has a plurality of magnet holes formed in the circumferential direction in the plate-shaped member 10. The plurality of magnet holes are formed by forming a plurality of magnet hole groups G1, each of which includes a certain number of magnet holes, side by side in the circumferential direction in the plate-shaped member 10. In the present embodiment, each magnet hole group G1 includes a set C1 having two magnet holes C1a and C1b adjacent to each other in the circumferential direction, and a set C2 having three magnet holes C2a, C2b, and C2c formed on a radially inner side of the set C1 and adjacent to each other in the circumferential direction. Therefore, a plurality of sets C1 are formed side by side in the circumferential direction in the plate-shaped member 10. The set C2 surrounds the radially inner side of the set C1. In each set C1, a bridge portion B1 extending in the radial direction is formed between the adjacent magnet holes C1a and C1b. The bridge portion B1 is a portion formed between the adjacent magnet holes C1a and C1b and having a width smaller than that of other portions.

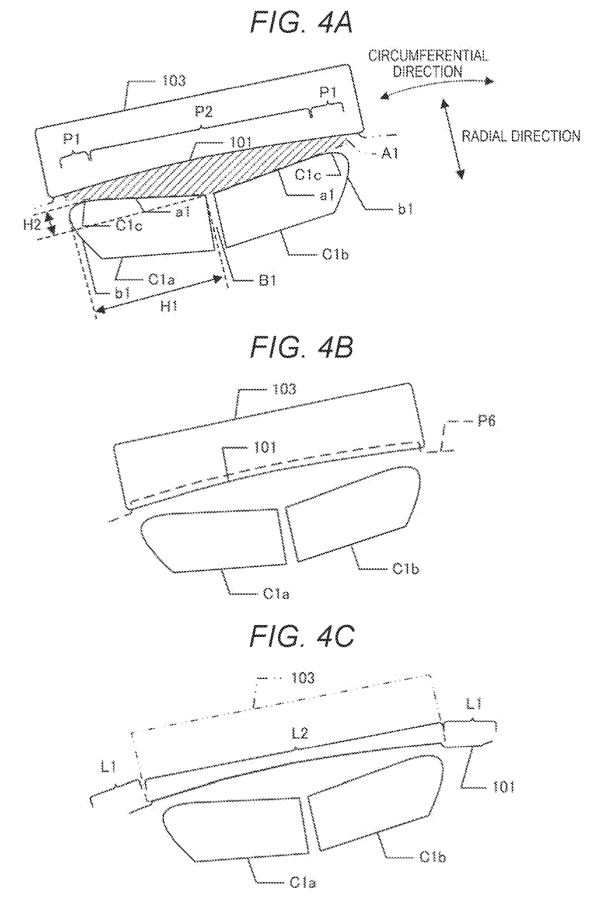

Each of the magnet holes C1a, C1b, C2a, C2b, and C2c in the magnet hole group G1 has long sides a1 facing each other and short sides b1 shorter than the long sides a1 and connecting both ends of the long sides a1. As illustrated in FIG. 4A to be described later, a length H1 of the long side a1 in the circumferential direction is larger than a length H2 of the long side a1 in the radial direction. In the present embodiment, the magnet holes C1a and C1b are formed in a substantially quadrangular shape. The magnet holes C1a and C1b are arranged in a gentle substantially V shape so that a distance between the outer peripheral edge 101 in a region of interest A1 and a closest portion C1c to be described later is smallest and a distance between the outer peripheral edge 101 in the region of interest A1 and an end portion at a radially outer side of the bridge portion B1 is largest. The magnet holes formed by the long sides a1 and the short sides b1 may be in any shape and arranged in any manner, and may be provided in any number.

### 2. Manufacturing Procedures of Iron Core Piece

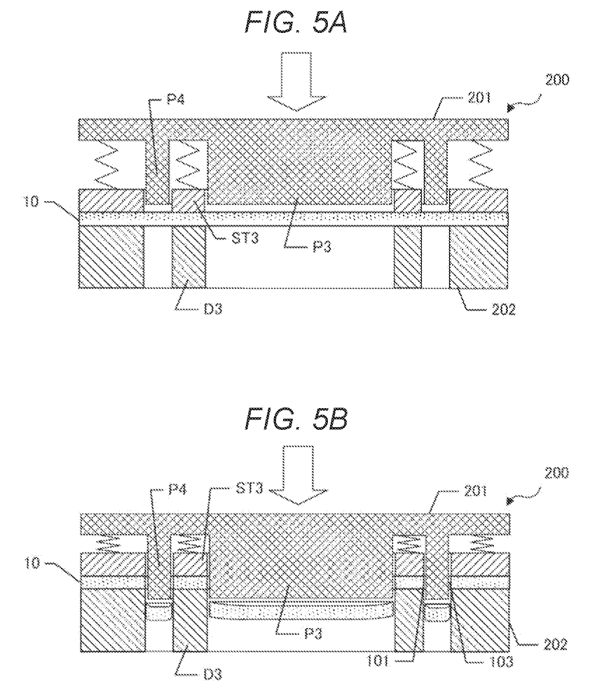

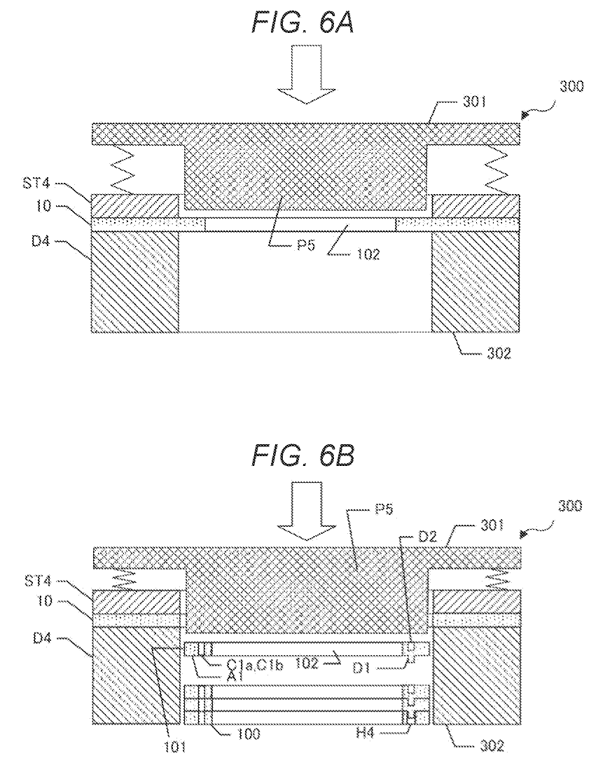

FIG. 3 is a diagram illustrating a flow of the method for manufacturing the iron core piece. FIG. 4A is an enlarged plan view illustrating a portion B in FIG. 2 and illustrates a state around the region of interest A1 after step S120 in FIG. 3. FIG. 4B is an enlarged plan view illustrating the portion B in FIG. 2 and illustrates a punching line in step S130 in FIG. 3. FIG. 4C is an enlarged plan view illustrating the portion B in FIG. 2 and illustrates a state around the region of interest A1 after step S130 in FIG. 3. FIG. 5A is a schematic cross-sectional view of a mold before molding in step S120 in FIG. 3. FIG. 5B is a schematic cross-sectional view of the mold after molding in step S120 in FIG. 3. FIG. 6A is a schematic cross-sectional view of a mold before molding in step S130 in FIG. 3. FIG. 6B is a schematic cross-sectional view of the mold after molding in step S130 in FIG. 3.

First, a configuration of a mold 200 illustrated in FIGS. 5A and 5B will be described. The mold 200 includes an upper mold 201 and a lower mold 202. The upper mold 201 includes a punch P3 that protrudes downward in an upper-lower direction and punches the inner peripheral edge 102 of the iron core piece 100, a punch P4 that protrudes downward in the upper-lower direction and punches an outer peripheral hole 103, and a stripper ST3 that presses the plate-shaped member 10 from above in the upper-lower direction by a pressing force of a spring. The lower mold 202 includes a die D3 that supports the pressing force of the stripper ST3 from below in the upper-lower direction. The stripper ST3 and the die D3 sandwich a radially inner side and a radially outer side of the outer peripheral edge 101 (at a position where the outer peripheral edge 101 is to be formed) of the iron core piece 100 in the plate-shaped member 10. To sandwich the radially inner side of the outer peripheral edge 101 of the iron core piece 100 means to sandwich a region on the radially inner side of the outer peripheral edge 101 in a state where a minimum necessary clearance for punching the outer peripheral hole 103 is secured. To sandwich the radially outer side of the outer peripheral edge 101 of the iron core piece 100 means to sandwich a region on the radially outer side of the outer peripheral edge 101 in the state where the minimum necessary clearance for punching the outer peripheral hole 103 is secured.

Next, a configuration of a mold 300 illustrated in FIGS. 6A and 6B will be described. The mold 300 includes an upper mold 301 and a lower mold 302. The upper mold 301 includes a punch P5 that protrudes downward in the upper-lower direction and punches the outer peripheral edge 101 of the iron core piece 100, and a stripper ST4 that presses the plate-shaped member 10 from above in the upper-lower direction by a pressing force of a spring. The lower mold 302 includes a die D4 that supports the pressing force of the stripper ST4 from below in the upper-lower direction. The stripper ST4 and the die D4 sandwich a portion on the radially outer side of the outer peripheral edge 101 in the plate-shaped member 10. No die is provided below the punch P5 in the upper-lower direction, and the outer peripheral edge 101 (parts L1 between edge portions L2 on the radially inner side of the outer peripheral hole 103 as illustrated in FIG. 4C) of the iron core piece 100 is punched with a pressing force of the punch P5 from above in the upper-lower direction being not supported from below in the upper-lower direction.

It is also possible to sandwich inside of the outer peripheral edge 101 of the iron core piece 100 by a stripper and a die and punch outside of the outer peripheral edge 101 of the iron core piece 100 by a punch. However, in this case, as described later, the punched iron core pieces 100 cannot be riveted to each other, and thus, in the present embodiment, the outside of the outer peripheral edge 101 of the iron core piece 100 is sandwiched by the stripper ST4 and the die D4, and the inside of the outer peripheral edge 101 of the iron core piece 100 is punched by the punch P5 without being supported from below in the upper-lower direction.

The flow of the method for manufacturing the iron core piece will be described with reference to FIG. 3. Here, as illustrated in FIG. 4A, in the present embodiment, a region surrounded by positions of the long sides a1 of the magnet holes C1a and C1b and the outer peripheral edge 101 of the iron core piece 100 is defined as the region of interest A1. The surrounded region does not mean a region completely closed from a region outside the surrounded region, and may be a region partially opened to the region outside the surrounded region. Processing in each step is performed while the plate-shaped member 10 having a coil shape is pulled out. In FIG. 3, vertical lines, horizontal lines, and oblique lines passing through the rotation axis Ax (see FIG. 1) are illustrated on the plate-shaped member 10. However, these lines are merely auxiliary lines, and such lines are neither actually illustrated on the plate-shaped member 10, nor linear shapes formed thereon.

First, a plurality of (two in the present embodiment) pilot holes H3 used for positioning in each step are formed in the plate-shaped member 10 (step S100). A plurality of (two in the present embodiment) pilot pins (not illustrated) protrude from an upper surface of a mold base in each step, and positioning in each step is performed by fitting the plurality of pilot pins into the plurality of pilot holes H3.

Here, as illustrated in FIG. 6B, each iron core piece 100 to be punched in step S130 to be described later includes a plurality of (eight in the present embodiment) riveting protrusions D1 protruding downward from a lower surface of the iron core piece 100 and a plurality of (eight in the present embodiment) protrusion accommodating grooves D2 formed on an upper surface of the iron core piece 100 corresponding to the riveting protrusions D1, and riveting and fixing are performed by accommodating and fitting the riveting protrusions D1 to the protrusion accommodating grooves D2 of the iron core piece 100 manufactured previously. Since it is necessary to separate, from the iron core piece 100 manufactured last in a previous set, the iron core piece 100 manufactured first in a set of the plurality of iron core pieces 100 constituting a laminated iron core, the riveting protrusions D1 or the protrusion accommodating grooves D2 are not formed, and instead of this, a plurality of (eight in the present embodiment) protrusion accommodating holes H4 are formed (step S105).

Then, the plurality of magnet holes C2a, C2b, and C2c constituting the set C2 are formed in the plate-shaped member 10 by a punch in a state where peripheries of the plurality of magnet holes (at positions where the magnet holes are to be formed) C2a, C2b, and C2c constituting the set C2 arranged side by side in the circumferential direction are sandwiched by a stripper and a die (step S110). Although a mold is not illustrated, configurations and functions of the punch, the stripper, and the die are the same as those described with reference to FIGS. 5A, 5B, 6A, and 6B. That is, the mold includes an upper mold and a lower mold. The upper mold includes the punch that protrudes downward in the upper-lower direction and punches the plurality of magnet holes C2a, C2b, and C2c, and the stripper that presses the plate-shaped member 10 from above in the upper-lower direction by a pressing force of a spring. The lower mold includes the die that supports the pressing force of the stripper from below in the upper-lower direction. The stripper and the die sandwich the peripheries of the plurality of magnet holes (at the positions where the magnet holes are to be formed) C2a, C2b, and C2c constituting the set C2 arranged side by side in the circumferential direction in the plate-shaped member 10. To sandwich the peripheries of the plurality of magnet holes (at the positions where the magnet holes are to be formed) C2a, C2b, and C2c means to sandwich a region surrounding the magnet holes C2a, C2b, and C2c in a state where a minimum necessary clearance for punching the magnet holes C2a, C2b, and C2c is secured.

Thereafter, the plurality of magnet holes C1a and C1b constituting the set C1 are formed in the plate-shaped member 10 by a punch in a state where peripheries of the plurality of magnet holes (at positions where the magnet holes are to be formed) C1a and C1b constituting the set C1 arranged side by side in the circumferential direction are sandwiched by a stripper and a die (step S115, magnet hole forming step). Although a mold is not illustrated, configurations and functions of the punch, the stripper, and the die are the same as those described with reference to FIGS. 5A, 5B, 6A, and 6B. That is, the mold includes an upper mold and a lower mold. The upper mold includes the punch that protrudes downward in the upper-lower direction and punches the plurality of magnet holes C1a and C1b, and the stripper that presses the plate-shaped member 10 from above in the upper-lower direction by a pressing force of a spring. The lower mold includes the die that supports the pressing force of the stripper from below in the upper-lower direction. The stripper and the die sandwich the peripheries of the plurality of magnet holes (at the positions where the magnet holes are to be formed) C1a and C1b constituting the set C1 arranged side by side in the circumferential direction in the plate-shaped member 10. To sandwich the peripheries of the plurality of magnet holes (at the positions where the magnet holes are to be formed) C1a and C1b means to sandwich a region surrounding the magnet holes C1a and C1b in a state where a minimum necessary clearance for punching the magnet holes C1a and C1b is secured.

Then, at positions adjacent to radially inner sides of the plurality of magnet hole groups G1 arranged side by side in the circumferential direction, the inner peripheral edge 102 is punched by the punch P3 illustrated in FIGS. 5A and 5B (see FIGS. 1 and 2), and the outer peripheral edge 101 of the iron core piece 100 is formed in at least a part (all in the present embodiment) of a portion P2 excluding a circumferential end portion P1 of the outer peripheral edge 101 in the region of interest A1 (see FIG. 4A) in a state where the radially inner side of the outer peripheral edge 101 (at the position where the outer peripheral edge 101 is to be formed) of the iron core piece 100 is sandwiched by the stripper ST3 and the die D3 (see FIGS. 5A and 5B) (step S120, outer peripheral edge forming step). In the present embodiment, as illustrated in FIG. 5B, the penetrated outer peripheral hole 103 is punched by the punch P4 in a manner of being adjacent to the radially outer side of the outer peripheral edge 101 of the iron core piece 100, and an edge portion on the radially inner side of the outer peripheral hole 103 constitutes the outer peripheral edge 101 of the iron core piece 100. By forming the outer peripheral edge 101 of the iron core piece 100 in the state where the radially inner side of the outer peripheral edge 101 of the iron core piece 100 is sandwiched by the stripper ST3 and the die D3, deformation of the iron core piece 100 in the region of interest A1 in the outer peripheral edge forming step can be prevented.

As illustrated in FIGS. 4A and 4B, a length of the outer peripheral edge 101 of the iron core piece 100 in the circumferential direction formed in the outer peripheral edge forming step is half or greater than half of (equal to in the present embodiment) a length of the portion P2 excluding the circumferential end portion P1 of the outer peripheral edge 101 in the region of interest A1. Accordingly, since the outer peripheral edge 101 of the iron core piece 100 is formed in advance in the state where the radially inner side of the outer peripheral edge 101 (at the position where the outer peripheral edge 101 is to be formed) of the iron core piece 100 is sandwiched by the stripper ST3 and the die D3 over a long section before the punching step, an effect of preventing deformation in the region of interest A1 in the punching step can be enhanced.

As illustrated in FIGS. 4A and 4B, the outer peripheral edge 101 of the iron core piece 100 formed in the outer peripheral edge forming step includes the outer peripheral edge 101 of the iron core piece 100 radially outward of the bridge portion B1. Accordingly, by forming the outer peripheral edge 101 of the iron core piece 100 radially outward of the bridge portion B1, deformation of the bridge portion B1 in the punching step can be prevented.

As illustrated in FIGS. 4A and 4B, the outer peripheral edge 101 of the iron core piece 100 formed in the outer peripheral edge forming step includes the outer peripheral edge 101 of the iron core piece 100 radially outward of the closest portion C1c at which the magnet holes C1a and C1b are closest to the outer peripheral edge 101 of the iron core piece 100. Accordingly, by forming the outer peripheral edge 101 of the iron core piece 100 radially outward of the closest portion C1c, deformation around the closest portion C1c in the punching step can be prevented.

After step S120, by pressing a portion corresponding to the iron core piece with a plurality of (eight in the present embodiment) punches, the riveting protrusions D1 protruding from the lower surface of the iron core piece 100 and the protrusion accommodating grooves D2 recessed from the upper surface of the iron core piece 100 are simultaneously formed (step S125). As described above, since the protrusion accommodating holes H4 are formed in the iron core piece 100 manufactured first among the set of the plurality of iron core pieces 100 constituting the laminated iron core, the riveting protrusions D1 and the protrusion accommodating grooves D2 are not formed.

Finally, as illustrated in FIGS. 2, 4A, and 4C, the iron core piece 100 is punched such that the parts L1 between the edge portions L2 on the radially inner side of the outer peripheral hole 103 in a plurality of regions of interest A1 are connected in the circumferential direction, the parts L1 constituting the outer peripheral edge 101 of the iron core piece 100 formed in the outer peripheral edge forming step (step S130, punching step). At this time, as indicated by a punching line P6 in FIG. 4B, an outer peripheral edge of the punch P5 is shifted to the radially outer side from the edge portion on the radially inner side of the outer peripheral hole 103 in a range of the outer peripheral hole 103 extending in the circumferential direction. Accordingly, the plate-shaped member 10 can be prevented from being cut twice. As a result of the punching, as illustrated in FIG. 4C, the punching line P6 formed by the outer peripheral edge of the punch P5 in the punching step forms the outer peripheral edge 101 in the parts L1 between the edge portions L2 on the radially inner side of the outer peripheral hole 103. As described above, the punched iron core pieces 100 are laminated in a riveted state, and are conveyed to a next step after a certain number of iron core pieces 100 are laminated.

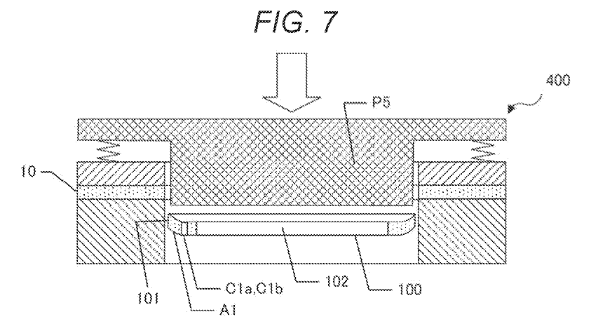

As described above, the following effects are attained according to the present embodiment. In the related-art manufacturing method not including the outer peripheral edge forming step as described above, it is necessary to punch the iron core piece 100 in the punching step in the plate-shaped member 10 in which the magnet holes C1a and C1b are formed. In this state, as illustrated in FIG. 7, when the outer peripheral edge 101 of the iron core piece 100 is punched by the punch P5, a region (the region of interest A1) surrounded by the magnet holes C1a and C1b and the outer peripheral edge 101 of the iron core piece 100 may bend downward and deform. On the other hand, in the present embodiment, after the outer peripheral edge forming step of forming the outer peripheral edge 101 of the iron core piece 100 in at least a part of the portion P2 excluding the circumferential end portion P1 of the outer peripheral edge 101 in the region of interest A1, the iron core piece 100 is punched in the punching step such that parts between the outer peripheral edges 101 of the iron core piece 100 formed in the outer peripheral edge forming step in the plurality of regions of interest A1 are connected in the circumferential direction. Therefore, in the region of interest A1 in which deformation is likely to occur, it is not necessary to perform punching on the outer peripheral edge 101 of the iron core piece 100 formed in the outer peripheral edge forming step, and deformation in the region of interest A1 in the punching step can be prevented. Therefore, deformation of the iron core piece 100 in the region (region of interest A1) surrounded by the magnet holes C1a and C1b and the outer peripheral edge 101 of the iron core piece 100 can be prevented.

In a product shape in which the magnet holes C1a and C1b are arranged near the outer peripheral edge 101 of the iron core piece 100 as in the present embodiment, the bridge portion B1 may be stretched or bent in the punching step, and this may adversely affect a strength or a shape of the bridge portion B1. This is because, in the punching step, a product side of the plate-shaped member 10, that is, the radially inner side of the outer peripheral edge 101 of the iron core piece 100 cannot be sandwiched and supported, and a tensile stress generated by punching may concentrate on the bridge portion B1. On the other hand, in the present embodiment, in the state where the radially inner side of the outer peripheral edge 101 of the iron core piece 100 is sandwiched by the stripper ST3 and the die D3, the outer peripheral edge 101 of the iron core piece 100 is formed in at least a part of the portion P2 excluding the circumferential end portion P1 of the outer peripheral edge 101 in the region of interest A1, and then an outer diameter of the iron core piece 100 is punched in the punching step. Accordingly, a punching force does not propagate to the bridge portion B1 in the punching step, and a stress of the bridge portion B1 can be reduced to prevent deformation.

### 3. Other Embodiments:

The above embodiment is an example for carrying out this disclosure, and various other embodiments can be adopted. For example, in the above embodiment, the outer peripheral edge forming step is performed after the magnet hole forming step, and then the punching step is performed, but this disclosure can also be applied to a case where the punching step is performed after one of the two steps (the magnet hole forming step and the outer peripheral edge forming step) is performed first and the other is performed later, or after both of the two steps are performed simultaneously. In the outer peripheral edge forming step, a position of a long side means the position of the long side of a formed magnet hole when the magnet hole is already formed, and means the position of the long side of a magnet hole to be formed when the magnet hole is not yet formed.

In the above embodiment, the region surrounded by the positions of the long sides a1 and the outer peripheral edge 101 of the iron core piece 100 is defined as the region of interest A1 (see FIGS. 1 and 4A). Since the two magnet holes C1a and C1b are formed side by side in the circumferential direction, two long sides a1 are formed side by side in the circumferential direction. In this case, the region surrounded by the two long sides a1 and the outer peripheral edge 101 of the iron core piece 100 is defined as one region of interest A1. However, a region surrounded by one long side a1 and the outer peripheral edge 101 of the iron core piece 100 can be defined as one region of interest, and a region surrounded by the other long side a1 and the outer peripheral edge 101 of the iron core piece 100 can also be defined as another region of interest. When only one magnet hole is formed, a region surrounded by one long side a1 and the outer peripheral edge 101 of the iron core piece 100 can be defined as the region of interest A1. Further, when three or more magnet holes are formed side by side in the circumferential direction and three or more long sides a1 are formed side by side in the circumferential direction, a region surrounded by each long side a1 and the outer peripheral edge 101 of the iron core piece 100 may be defined as a separate region of interest, or a region surrounded by a line segment, which is formed by connecting three or more long sides formed side by side in the circumferential direction, and the outer peripheral edge 101 of the iron core piece 100 may be defined as one region of interest.

In the above embodiment, in the outer peripheral edge forming step, the outer peripheral edge 101 of the iron core piece 100 is formed in the entire portion P2 excluding the circumferential end portion P1 of the outer peripheral edge 101 in the region of interest A1, but this disclosure can also be applied to a case where the outer peripheral edge 101 of the iron core piece 100 is formed in at least a part of the portion P2 excluding the circumferential end portion P1 of the outer peripheral edge 101 in the region of interest A1. In the outer peripheral edge forming step, the outer peripheral edge 101 of the iron core piece 100 may contain at least a central portion of the outer peripheral edge 101 in the circumferential direction in the region of interest A1.

In the above embodiment, the plurality of magnet holes formed in the circumferential direction in the plate-shaped member 10 are formed such that the plurality of magnet hole groups G1 are formed side by side in the circumferential direction in the plate-shaped member 10 in the present embodiment, and each of the magnet hole groups G1 includes the set C1 having the two magnet holes C1a and C1b adjacent to each other in the circumferential direction, and the set C2 having the three magnet holes C2a, C2b, and C2c formed on the radially inner side of the set C1 and adjacent to each other in the circumferential direction. However, this disclosure can also be applied to a configuration in which the plurality of magnet holes formed in the circumferential direction in the plate-shaped member 10 are formed with, without the set C2, a plurality of sets C1 side by side in the circumferential direction in the plate-shaped member 10.

In the above embodiment, in the outer peripheral edge forming step, the penetrated outer peripheral hole 103 is adjacent to the radially outer side of the outer peripheral edge 101 of the iron core piece 100, and the edge portion on the radially inner side of the outer peripheral hole 103 constitutes the outer peripheral edge 101 of the iron core piece 100. However, it is not necessarily required to form a through hole, and, for example, a product may pass through a die for punching while being sandwiched by a knockout and a punch, and the product may be pushed back into an original material by the knockout (pushback).

In the magnet hole forming step, the number of magnet holes is not limited to the number described in the above embodiment. In the above embodiment, the two magnet holes C1a and C1b adjacent to each other in the circumferential direction are formed side by side in the circumferential direction in the plate-shaped member 10, and three or more magnet holes adjacent to each other in the circumferential direction may be formed side by side in the circumferential direction in the plate-shaped member 10. One magnet hole may be formed instead of the two magnet holes C1a and C1b adjacent to each other in the circumferential direction.

In the magnet hole forming step, the shape of a magnet hole is not limited to that in the above embodiment, and various shapes can be adopted. That is, each of the magnet holes C1a, C1b, C2a, C2b, and C2c in the magnet hole group G1 may have the long sides a1 facing each other and the short sides b1 shorter than the long sides a1 and connecting both ends of the long sides a1, and any shape formed by the long sides and the short sides may be adopted as long as the long sides and the short sides connecting both ends of the long sides can be recognized. For example, each of the magnet holes C1a, C1b, C2a, C2b, and C2c in the magnet hole group G1 may have a substantially rectangular shape. For each of the magnet holes C1a, C1b, C2a, C2b, and C2c in the magnet hole group G1, the long sides a1 and the short sides b1 may be formed in an arc shape. For each of the magnet holes C1a, C1b, C2a, C2b, and C2c in the magnet hole group G1, the long sides a1 facing each other, as well as the short sides b1 facing each other, are not necessarily required to have the same length, and each magnet hole may have a substantially trapezoidal shape in which one long side a1 is longer than the other long side a1, or may have a substantially trapezoidal shape in which one short side b1 is longer than the other short side b1.

In the magnet hole forming step, the arrangement of the magnet holes is not limited to that in the above embodiment, and various arrangements can be adopted. For example, in the above embodiment, the magnet holes C1a and C1b are arranged in a gentle substantially V shape opening toward the outer peripheral edge 101, and may be arranged on a straight line. The magnet holes C1a and C1b may be arranged such that a distance between the outer peripheral edge 101 in the region of interest A1 and the closest portion C1c is constant along the circumferential direction (for example, such that a portion having a width smaller than that of other portions extends across the entire region of interest A1).

According to an aspect of this disclosure, a method for manufacturing an iron core piece constituting a laminated iron core based on a plate-shaped member and having a plurality of magnet holes arranged side by side in a circumferential direction, includes: a magnet hole forming step of forming the plurality of magnet holes in the plate-shaped member in a state where peripheries of the plurality of magnet holes are sandwiched by a stripper and a die, each of the plurality of magnet holes having long sides that face each other and short sides that are shorter than the long sides and connect both ends of the respective long sides, a length of the long sides in the circumferential direction being larger than a length thereof in a radial direction; an outer peripheral edge forming step of defining a region surrounded by positions of the long sides and an outer peripheral edge of the iron core piece as a region of interest and forming the outer peripheral edge of the iron core piece in at least a part of a portion excluding a circumferential end portion of an outer peripheral edge in the region of interest in a state where a radially inner side of the outer peripheral edge of the iron core piece is sandwiched by a stripper and a die; and a punching step of punching the iron core piece such that parts between outer peripheral edges of the iron core piece that are formed in the outer peripheral edge forming step in a plurality of regions of interest are connected in the circumferential direction.

That is, the method for manufacturing an iron core piece includes, before the step of punching the iron core piece, the outer peripheral edge forming step of forming the outer peripheral edge of the iron core piece in at least a part of a portion excluding the circumferential end portion of the outer peripheral edge in the region of interest in the state where the radially inner side of the outer peripheral edge of the iron core piece is sandwiched by the stripper and the die. By forming the outer peripheral edge of the iron core piece in the state where the radially inner side of the outer peripheral edge of the iron core piece is sandwiched by the stripper and the die, deformation of the iron core piece in the region of interest in the outer peripheral edge forming step can be prevented. Since the iron core piece is punched in the punching step such that the parts between the outer peripheral edges of the iron core piece that are formed in the outer peripheral edge forming step in the plurality of regions of interest are connected in the circumferential direction, it is not necessary to perform punching on the outer peripheral edges of the iron core piece that are formed in the outer peripheral edge forming step in the regions of interest in which deformation is likely to occur, and the deformation in the regions of interest in the punching step can be prevented.

Therefore, deformation of the iron core piece in the region surrounded by the magnet holes and the outer peripheral edge of the iron core piece can be prevented.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method for manufacturing an iron core piece constituting a laminated iron core based on a plate-shaped member and having a plurality of magnet holes arranged side by side in a circumferential direction, the method comprising:
a magnet hole forming step of forming the plurality of magnet holes in the plate-shaped member in a state where peripheries of the plurality of magnet holes are sandwiched by a stripper and a die, each of the plurality of magnet holes having long sides that face each other and short sides that are shorter than the long sides and connect both ends of the respective long sides, a length of the long sides in the circumferential direction being larger than a length thereof in a radial direction;
an outer peripheral edge forming step of defining a region surrounded by positions of the long sides and an outer peripheral edge of the iron core piece as a region of interest and forming the outer peripheral edge of the iron core piece in at least a part of a portion excluding a circumferential end portion of an outer peripheral edge in the region of interest in a state where a radially inner side of the outer peripheral edge of the iron core piece is sandwiched by a stripper and a die; and
a punching step of punching the iron core piece such that parts between outer peripheral edges of the iron core piece that are formed in the outer peripheral edge forming step in a plurality of regions of interest are connected in the circumferential direction.

2. The method for manufacturing an iron core piece according to claim 1, wherein
in the magnet hole forming step, a plurality of sets each including two magnet holes adjacent to each other in the circumferential direction are formed side by side in the circumferential direction in the plate-shaped member, and a bridge portion extending in the radial direction is formed between the magnet holes adjacent to each other in each set.

3. The method for manufacturing an iron core piece according to claim 1, wherein
a length of the outer peripheral edge of the iron core piece in the circumferential direction formed in the outer peripheral edge forming step is half or greater than half of a length of the portion excluding the circumferential end portion of the outer peripheral edge in the region of interest.

4. The method for manufacturing an iron core piece according to claim 2, wherein
the outer peripheral edge of the iron core piece formed in the outer peripheral edge forming step includes the outer peripheral edge of the iron core piece radially outward of the bridge portion.

5. The method for manufacturing an iron core piece according to claim 1, wherein
the outer peripheral edge of the iron core piece formed in the outer peripheral edge forming step includes the outer peripheral edge of the iron core piece radially outward of a closest portion at which the magnet holes are closest to the outer peripheral edge of the iron core piece.

6. The method for manufacturing an iron core piece according to claim 2, wherein
the outer peripheral edge of the iron core piece formed in the outer peripheral edge forming step includes the outer peripheral edge of the iron core piece radially outward of a closest portion at which the magnet holes are closest to the outer peripheral edge of the iron core piece.

7. The method for manufacturing an iron core piece according to claim 3, wherein
the outer peripheral edge of the iron core piece formed in the outer peripheral edge forming step includes the outer peripheral edge of the iron core piece radially outward of a closest portion at which the magnet holes are closest to the outer peripheral edge of the iron core piece.
